(19) United States
(12) Patent Application Publication
(10) Pub. No.: US 2024/0354634 A1
(43) Pub. Date: Oct. 24, 2024

(54) SYSTEM FOR ENHANCING THE QUALITY OF USER GENERATED CONTENT

(71) Applicant: Google LLC, Mountain View, CA (US)

(72) Inventor: Moritz Koehler, Zürich (CH)

(21) Appl. No.: 18/136,277

(22) Filed: Apr. 18, 2023

(51) Int. Cl. G06N 20/00

(52) U.S. Cl. CPC G06N 20/00

(57) ABSTRACT

A method includes obtaining a plurality of content items of a content creator and associated content item metrics. The method further includes identifying, based on the plurality of content items and associated content item metrics, an output of a generative machine learning model that is trained on a subset of content items with content item metrics satisfying one or more scoring criteria. The output of the generative machine learning model provides a representation for an additional content item. The additional content item, when created based on the representation, is predicted to have one or more content item metrics that satisfy the one or more scoring criteria. The method further includes providing for presentation to the content creator the representation for the additional content item.

### TECHNICAL FIELD

Aspects and implementations of the present disclosure relate to content sharing platforms, and more specifically to generating representations of content items.

### BACKGROUND

A platform (e.g., a content sharing platform) can transmit (e.g., stream) content items to client devices connected to the platform via a network. The platform may track metrics associated with the transmitted content items and may present at least some of the metrics to content creators.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

Systems and method are disclosed for generating representations of content items. In some implementations, a method includes obtaining a plurality of content items of a content creator and associated content item metrics. The method further includes, identifying, based on the plurality of content items and associated content item metrics, an output of a generative machine learning model that is trained on a subset of content items with content item metrics satisfying one or more scoring criteria. The output of the generative machine learning model provides a representation for an additional content item. The additional content item, when created based on the representation, is predicted to have one or more content item metrics that satisfy the one or more scoring criteria. The method further includes, providing for presentation to the content creator the representation for the additional content item.

In some embodiments, a content item metric of the associated content item metrics includes at least one of: a number of times users watched the content item, a duration of time users watched the content item, a number of “likes” given to the content item, or an amount of revenue generated by the content item.

In some embodiments, the representation for the additional content item includes at least one of a title for the additional content item, a description for the additional content item, an image to graphically represent the additional content item, or a video clip to graphically represent the additional content item.

In some embodiments, the generative machine learning model is trained by obtaining a plurality of content items of a content item platform. The generative machine learning model is further trained by obtaining a plurality of content item metrics associated with each content item of the plurality of content items of the content item platform. The generative machine learning model is further trained by selecting, from the plurality of content items, the subset of content items each having content item metrics that satisfy the one or more scoring criteria. The generative machine learning model is further trained by providing the subset of content items as training input to the generative machine learning model.

In some embodiments, the generative machine learning model includes a generative adversarial network. The generative adversarial network includes a generator trained to generate representations for additional content items similar to the plurality of content items. The generative adversarial network further includes a discriminator trained to reject generated representations for additional content items that are dissimilar to the plurality of content items.

In some embodiments, the generative machine learning model is trained by obtaining a plurality of content items of a content item platform. The generative machine learning model is further trained by obtaining a plurality of content item metrics associated with each content item of the plurality of content items of the content item platform. The generative machine learning model is further trained by selecting, from the plurality of content items, the subset of content items each having content item metrics that satisfy the one or more scoring criteria. The generative machine learning model is further trained by selecting a prompt template of a plurality of prompt templates to present information pertaining to the subset of content items. The generative machine learning model is further trained by modifying the prompt template based on the content item metrics of the subset of content items. The generative machine learning model is further trained by providing the modified prompt template as training input to the generative machine learning model. In some embodiments, the information pertaining to the subset of content items comprises one or more metadata characteristics of the subset of content items.

In another aspect, a computing system includes a memory and one or more processors, coupled to the memory, to obtain a plurality of content items of a content creator and associated content item metrics. The one or more processors are further to identify, based on the plurality of content items and associated content item metrics, an output of a generative machine learning model that is trained on a subset of content items with content item metrics satisfying one or more scoring criteria. The output of the generative machine learning model provides a representation for an additional content item. The additional content item, when created based on the representation, is predicted to have one or more content item metrics that satisfy the one or more scoring criteria. The one or more processors are further to provide for presentation to the content creator the representation for the additional content item.

In some embodiments, a content item metric of the associated content item metrics includes at least one of: a number of times users watched the content item, a duration of time users watched the content item, a number of “likes” given to the content item, or an amount of revenue generated by the content item.

In some embodiments, the representation for the additional content item includes at least one of a title for the additional content item, a description for the additional content item, an image to graphically represent the additional content item, or a video clip to graphically represent the additional content item.

In some embodiments, the generative machine learning model is trained by obtaining a plurality of content items of a content item platform. The generative machine learning model is further trained by obtaining a plurality of content item metrics associated with each content item of the plurality of content items of the content item platform. The generative machine learning model is further trained by selecting, from the plurality of content items, the subset of content items each having content item metrics that satisfy the one or more scoring criteria. The generative machine learning model is further trained by providing the subset of content items as training input to the generative machine learning model.

In some embodiments, the generative machine learning model includes a generative adversarial network. The generative adversarial network includes a generator trained to generate representations for additional content items similar to the plurality of content items. The generative adversarial network further includes a discriminator trained to reject generated representations for additional content items that are dissimilar to the plurality of content items.

In some embodiments, the generative machine learning model is trained by obtaining a plurality of content items of a content item platform. The generative machine learning model is further trained by obtaining a plurality of content item metrics associated with each content item of the plurality of content items of the content item platform. The generative machine learning model is further trained by selecting, from the plurality of content items, the subset of content items each having content item metrics that satisfy the one or more scoring criteria. The generative machine learning model is further trained by selecting a prompt template of a plurality of prompt templates to present information pertaining to the subset of content items. The generative machine learning model is further trained by modifying the prompt template based on the content item metrics of the subset of content items. The generative machine learning model is further trained by providing the modified prompt template as training input to the generative machine learning model. In some embodiments, the information pertaining to the subset of content items comprises one or more metadata characteristics of the subset of content items.

In another aspect, a non-transitory machine-readable storage medium stores instructions which, when executed, cause a processing device to perform operations including obtaining a plurality of content items of a content creator and associated content item metrics. The operations further include identifying, based on the plurality of content items and associated content item metrics, an output of a generative machine learning model that is trained on a subset of content items with content item metrics satisfying one or more scoring criteria. The output of the generative machine learning model provides a representation for an additional content item. The additional content item, when created based on the representation, is predicted to have one or more content item metrics that satisfy the one or more scoring criteria. The operations further include providing for presentation to the content creator the representation for the additional content item.

In some embodiments, a content item metric of the associated content item metrics includes at least one of: a number of times users watched the content item, a duration of time users watched the content item, a number of “likes” given to the content item, or an amount of revenue generated by the content item.

In some embodiments, the representation for the additional content item includes at least one of a title for the additional content item, a description for the additional content item, an image to graphically represent the additional content item, or a video clip to graphically represent the additional content item.

In some embodiments, the generative machine learning model is trained by obtaining a plurality of content items of a content item platform. The generative machine learning model is further trained by obtaining a plurality of content item metrics associated with each content item of the plurality of content items of the content item platform. The generative machine learning model is further trained by selecting, from the plurality of content items, the subset of content items each having content item metrics that satisfy the one or more scoring criteria. The generative machine learning model is further trained by providing the subset of content items as training input to the generative machine learning model.

In some embodiments, the generative machine learning model includes a generative adversarial network. The generative adversarial network includes a generator trained to generate representations for additional content items similar to the plurality of content items. The generative adversarial network further includes a discriminator trained to reject generated representations for additional content items that are dissimilar to the plurality of content items.

In some embodiments, the generative machine learning model is trained by obtaining a plurality of content items of a content item platform. The generative machine learning model is further trained by obtaining a plurality of content item metrics associated with each content item of the plurality of content items of the content item platform. The generative machine learning model is further trained by selecting, from the plurality of content items, the subset of content items each having content item metrics that satisfy the one or more scoring criteria. The generative machine learning model is further trained by selecting a prompt template of a plurality of prompt templates to present information pertaining to the subset of content items. The generative machine learning model is further trained by modifying the prompt template based on the content item metrics of the subset of content items. The generative machine learning model is further trained by providing the modified prompt template as training input to the generative machine learning model.

Optional features of one aspect may be combined with other aspects where appropriate.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for generating representations of content items, according to some embodiments.

FIG. 2 illustrates an example data flow diagram for generating representations of content items, according to some embodiments.

FIGS. 3A-C illustrate example user interfaces for displaying representations of content items, according to some embodiments.

FIG. 4 is a flow diagram of a method for generating representations of content items, according to some embodiments.

FIG. 5 is a block diagram illustrating a computer system, according to some embodiments.

### DETAILED DESCRIPTION

Aspects and implementations of the present disclosure relate to generating representations of content items, including representations related to new content items that have a high probability of success. Successful content items may include those with content item metrics that satisfy one or more scoring criteria. A platform (e.g., a content sharing platform) may have a remote server where content items are hosted and a corresponding local client (e.g., web browser, mobile application, desktop application, or the like) that enables a user to interact with the remote server. As a user interacts with the platform and the content items of the platform, the platform may record metrics related to the interactions (e.g., number of views, watch-time duration, number of “likes”, amount of revenue generated, etc.). The platform may present, to a content creator, metrics related to content items of the content creator. The metrics may be presented in a table, in a graph, in a chart, and/or as text. However, it can be difficult for a content creator to interpret the metrics and make decisions about future content items to create that will be successful. As a result, a content creator may create and upload content items that are unlikely to be successful, causing needless consumption of computing resources allocated to support the creation and upload operations of the content creator, as well as the presentation of such content items to end users who are likely to be dissatisfied with the presented content items.

Aspects of the present disclosure address the above and other deficiencies by facilitating creation of content items that have a high probability of success. In some embodiments, a machine learning model (e.g., a generative adversarial network (GAN), a generative language model, a large language model, etc.) may be trained, using successful content items of a content sharing platform, to generate representations for additional content items that have a high probability of success. Content items may be determined to be successful based on metrics associated with the content item that satisfy one or more scoring criteria. In some embodiments, a scoring criterion may be based on an amount of revenue generated by a content item (e.g., through advertising, viewers sending tips to creators, etc.). For example, a content item may be considered successful if the amount of revenue generated by the content item exceeds a predetermined threshold. In some embodiments, content items may be considered successful based on a combination (e.g., a linear combination) of metrics, including but not limited to, a watch count, a watch-time duration, a number of “likes”, revenue generated, demographic information of users interacting with the content, number of comments, etc. In some embodiments, scoring criteria for determining which content is successful may be selected by a content creator. For example, a first content creator may want to generate additional revenue from their content items and may select content items for training that resulted in a large amount of revenue, while a second content creator may want to increase the watch time of their content and may select content items for training that have high watch time content item metrics.

Content items of a content creator may be provided to the trained machine learning model, and the trained machine learning model may output one (or more) representations of additional content items. The additional content items, when created by a content creator based on the representation, may be predicted to have a high probability of success. Because content items of the content creator are provided to the machine learning model, the representations of additional content items generated by the trained machine learning model may be similar to (e.g., have the same theme as, have the same category as, etc.) the content items of the content creator. The trained machine learning model may receive content items of a first modality (e.g., image, video, text, audio, etc.) and may output a representation for an additional content item in the same or a different modality. For example, the trained machine learning model may receive video content items of the content creator and may output a video clip representation of an additional content item that the content creator may create. In some embodiments, the trained machine learning model may receive video content items of the content creator and may output an image (e.g., a thumbnail) representation of an additional content item or may output a text representation of an additional content item. The representation for the additional content item generated by the trained machine learning model may not be a complete content item and may provide inspiration to the content creator of a new content item to produce that may have a high probability of success.

Aspects of the present disclosure may provide technical advantages over previous solutions. Aspects of the present disclosure may, by providing to content creators representations for additional content items that have a high probability of success, reduce the number of low quality content items that are created, uploaded, stored and provided for presentation to users of a platform, thereby saving processing and storage resources of the platform, improving an overall quality of content of the platform, and increasing satisfaction with the operation of the platform by the content creators and content viewers.

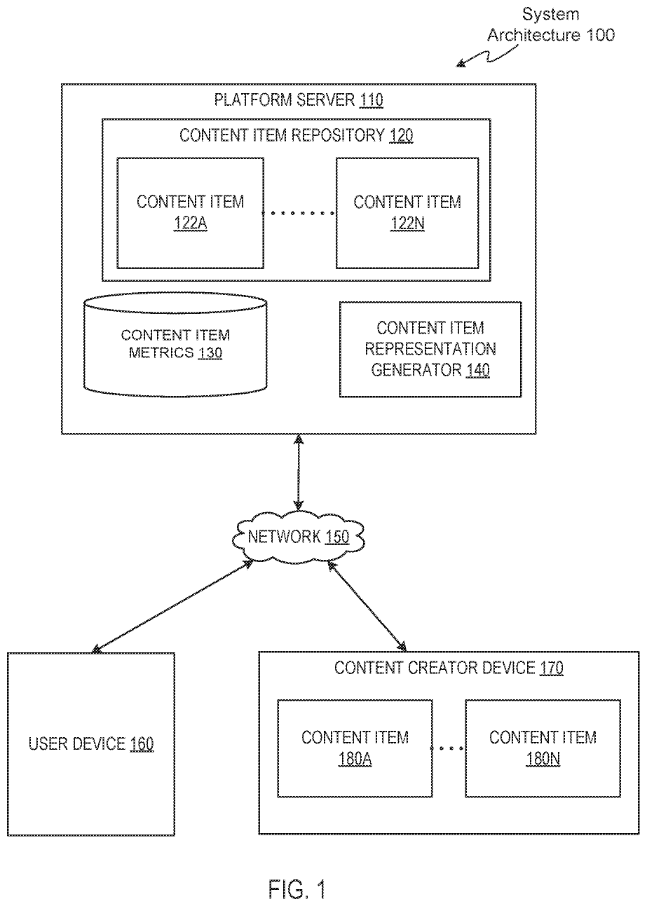

FIG. 1 illustrates an example system architecture 100 for generating representations of content items, according to some embodiments. System architecture 100 includes platform server 110, network 150, user device 160, and content creator device 170. Platform server 110 includes content item repository 120, content item metrics 130, and content item representation generator 140. Platform server 110 may include one or more servers and can enable users to consume, upload, share, search for, approve of (“like”), dislike, and/or comment on content items 122A-N of content item repository 120. Platform server 110 may include a website (e.g., a webpage) and/or application back-end software used to provide a user with access to content items (e.g., via user device 160). A content item (e.g., content item 122A) may correspond to a media file (e.g., a video file, an audio file, etc.) or a portion of a media file (e.g., a portion or a chunk of a video file, an audio file, etc.). As used herein, “media,” “media item,” “online media item,” “digital media,” “digital media item,” “content,” and “content item” can include an electronic file that can be executed or loaded using software, firmware, or hardware configured to present the digital content item to an entity. Examples of content items 122A-N may include, and are not limited to, digital video, digital movies, animated images, digital photos, digital music, digital audio, digital video games, collaborative media content presentations, website content, social media updates, electronic books, electronic journals, digital audio books, web blogs, software applications, etc.

Platform server 110 may be a rackmount server, a router computer, a server computer, a personal computer, a mainframe computer, a laptop computer, a tablet computer, a desktop computer, or the like. In some embodiments, platform server 110 may be connected to content item repository 120 via network 150, which may be a public network (e.g., the Internet), a private network (e.g., a local area network (LAN)), a wide area network (WAN), a wired network (e.g., Ethernet network), a wireless network (e.g., an 802.11 network), a cellular network (e.g., a Long Term Evolution (LTE) network), and/or a combination thereof. In some embodiments, content item repository 120 may be a part of platform server 110.

Content item repository 120 and/or content item metrics 130 may reside in memory (e.g., random access memory (RAM)), cache, drives (e.g., hard drive, solid state drive), flash drives, etc., and may be part of one or more database systems, one or more file systems, one or more distributed ledgers, or another type of component or device capable of storing data. Content item repository 120 and/or content item metrics 130 may include multiple storage components (e.g., multiple drives or multiple databases) that may also span multiple computing devices (e.g., multiple server computers). Content item repository 120 and/or content item metrics 130 may be persistent storage that is capable of storing data. A persistent storage may be a local storage unit or a remote storage unit, electronic storage units (e.g., main memory), or a similar storage unit. Persistent storage may be a monolithic device or a distributed set of devices.

Content item metrics 130 may include historical metrics related to user interactions with content items of platform server 110. For example, content item metrics 130 may include, for individual content items of platform server 110, historical data regarding the content item. The historical data may include how many users interacted with (e.g., watched, downloaded, played, listened to, clicked on, saw, etc.) the content item, how long users watched the content item, how many users commented on the content item, how many users approved of (e.g., “liked”) the content item, how much revenue was generated by the content item, etc.

User device 160 and/or content creator device 170 may include devices, such as televisions, smart phones, personal digital assistants, portable media players, laptop computers, electronic book readers, tablet computers, desktop computers, gaming consoles, set-top boxes, or the like. User device 160 may access one or more content items of platform server 110 (e.g., via network 150). User device 160 and/or content creator device 170 may include a content viewer. In some implementations, a content viewer can be an application that provides a graphical user interface (GUI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded content viewer (e.g., a Flash® player, an HTML5 player or any other media player) that is embedded in a web page (e.g., a web page that may provide information about a product sold by an online merchant). In another example, the content viewer can be a standalone application (e.g., a mobile application or app) that includes a media player that allows users to consume digital media items (e.g., digital video items, digital images, audio items, etc.). According to aspects of the disclosure, the content viewer can be a content sharing platform application for users to record, edit, and/or upload content for sharing on the platform. As such, the content viewer can be provided to user device 160 and/or content creator device 170 by the platform. For example, the content viewer may be an embedded content viewer that are embedded in web pages provided by the platform server 110.

Content item metrics may be recorded as user device 160 interacts with platform server 110 (e.g., via a media player). Content creator device 170 may upload content items 180A-N to platform server 110 (e.g., via network 150) to be included in content item repository 120. Content creator device 170 may receive, from platform server 110, one or more content item metrics 130 and/or one or more output representations for additional content items of content item representation generator 140.

Content item representation generator 140 may include a machine learning model trained, using successful content items of platform server 110, to generate representations of additional content items that have a high probability of being successful. In some embodiments, content item representation generator 140 includes a trained generative adversarial network (GAN) that includes a generator trained to generate representations for additional content items similar to content items received as input into the GAN. The trained GAN may also include a discriminator trained to reject generated representations for additional content items that are dissimilar to the content items received as input. The GAN may be trained using content items of platform server 110 that have associated content metrics that satisfy one or more scoring criteria (e.g., “successful” content items). The GAN may output a representation for an additional content item responsive to providing one or more content items of a content creator to the GAN. Because the GAN is trained on successful content items, the additional content item, when created by the content creator based on the output representation of the GAN, has a high probability of being successful.

In some embodiments, content item representation generator 140 may include a trained generative language model and/or a trained large language model. The generative language model may be trained using successful content items of platform server 110 and content item metrics associated with the successful content items. To generate training data, a prompt template may be selected from a plurality of prompt templates. The prompt template may include one or more placeholders to be replaced by information pertaining to the successful content items. In some embodiments, a prompt template may include placeholders for one or more metadata characteristics associated with the content items. The metadata characteristics may include a title of the content item, a category of the content item, a description of the content item, one or more tags associated with the content item, a target audience of the content item, and one or more content item metrics. For example, a prompt template containing “The video {{title}} had {{numberOfViews}} views” may be modified such that the title of a content item and the number of views associated with the content item are inserted in place of their respective placeholders. In some embodiments, the prompt template may include placeholders for information pertaining to more than one content item. The modified prompt template may be provided to the generative language model as training input. During an inference phase, responsive to receiving a modified prompt template, the generative language model may output a text representation of an additional content item. For example, the text representation may include a title and/or a description of the additional content item. In some embodiments, a trained machine learning model may be used to convert content items and associated content item metrics into text that can be provided to the generative language model.

Content item representation generator 140 may receive as input content items of a first modality (e.g., first media content type such as image, video, text, audio, etc.) and may output a representation for an additional content item in the same (or a different) modality. For example, content item representation generator 140 may receive video content items of a content creator as an input and may output a video clip representation for an additional content item that the content creator may create. In some embodiments, content item representation generator 140 may receive, as input, video content items of the content creator and may output an image (e.g., a thumbnail) to graphically represent the additional content item or may output a title and/or a description for the additional content item.

In some embodiments, a content creator may be able to query the generative machine learning model by providing a natural language prompt to platform server 110. As an example, the natural language prompt may be “what video should I create next in order to receive a higher viewership?” Responsive to receiving the request, platform server 110 may provide a plurality of content items of the content creator along with associated content item metrics to content item representation generator 140. Platform server 110 may provide for presentation to the content creator the output of content item representation generator 140—the representation for an additional content item. In some embodiments, platform server 110 may provide a user interface (UI) including a first portion presenting one or more representations of additional content items and a second portion with a media player to play an additional content item selected in the first portion.

In some embodiments, the generative machine learning model is trained on conversations between two users (e.g., email, online messaging, customer service chat, contract negotiations, etc.). The text conversations may have associated metrics such as text sentiment (e.g., positive, negative, neutral, etc.), conversation outcome (e.g., issue resolved, issue escalated, lost customer, etc.), duration of the conversation, and/or the like. Text conversations may be selected to be used during training based on the associated metrics satisfying one or more scoring criteria, such as having a positive sentiment and leading to resolution of an issue. During an inference phase, a user may provide one or more messages of a conversation to platform server 110. Platform server 110 may respond with one or more representations of additional content items (e.g., conversation messages) that may lead to a successful outcome in the conversation, as defined by the scoring criteria.

In general, functions described in implementations as being performed by platform server 110 can also be performed on the user device 160 and/or content creator device 170 in other implementations, if appropriate. In addition, the functionality attributed to a particular component can be performed by different or multiple components operating together. Platform server 110 can also be accessed as a service provided to other systems or devices through appropriate application programming interfaces, and thus is not limited to use in websites.

It should be noted that although some embodiments of the present disclosure are directed to a content sharing platform, embodiments of this disclosure can be applied to other types of platforms. For example, embodiments of the present disclosure can be applied to a content archive platform, a content storage platform, etc.

In implementations of the disclosure, a “user” or an “owner” can be represented as a single individual. However, other implementations of the disclosure encompass a “user” or an “owner” being an entity controlled by a set of users and/or an automated source. For example, a set of individual users or owners federated as a community in a social network can be considered a “user” or an “owner”. In another example, an automated consumer can be an automated ingestion pipeline, such as a topic channel, of platform server 110.

In situations in which the systems discussed here collect personal information about users (including owners), or can make use of personal information, the users can be provided with an opportunity to control whether platform server 110 collects user information (e.g., information about a user's social network, social actions or activities, profession, a user's preferences, or a user's current location), or to control whether and/or how to receive content from the content server that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by platform server 110.

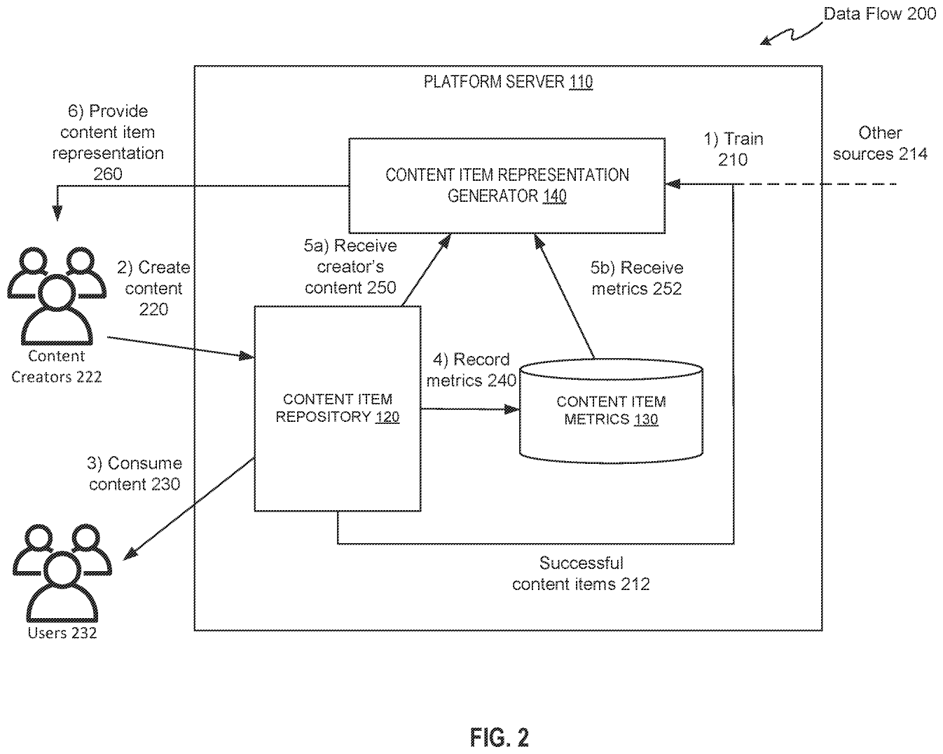

FIG. 2 illustrates an example data flow 200 for generating representations of content items, according to some embodiments. Content item representation generator 140 is trained (210) using successful content items 212 of content item repository 120. Successful content items 212 may be selected based on associated content item metrics that satisfy one or more scoring criteria. In some embodiments, content item representation generator 140 is also trained (210) using data from other sources 214. Other sources 214 may include content items of a different platform (e.g., other content sharing platform, social network platform, advertisement platform, etc.). Content creators 222 may create and/or upload (220) content to content item repository 120. Users 232 may consume (230) content of content item repository 120. Content item metrics may be recorded and stored (240) in content item metrics 130. Content item representation generator 140 may receive (250) a content creator's content items and/or receive (252) content item metrics associated with the content creator's content items. Based on the received content items and/or content item metrics, content item representation generator 140 may provide (260) a representation for an additional content item that may have a high probability of being successful. One or more of such representations can be displayed to a content creator via a user interface that is discussed in more detail herein.

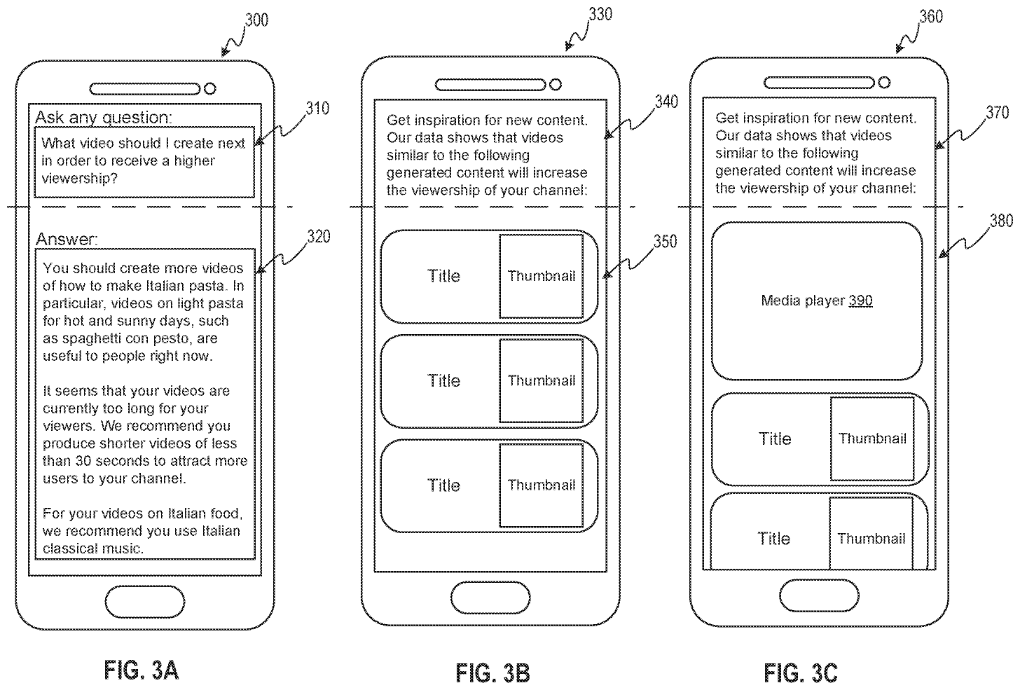

FIGS. 3A-C illustrate example user interfaces for displaying representations of content items, according to some embodiments. FIG. 3A depicts an example user interface for displaying textual representations of content items to a content creator. For example, client device 300 may be a device of a content creator and may display a UI including a first portion 310 (shown above the dashed line) and a second portion 320 (shown below the dashed line). First portion 310 may include a text-input field that allows the content creator to enter a prompt to generate additional content item representations. In some embodiments, the prompt is a natural language prompt. For example, the prompt may be a question regarding what video should be created to receive a higher viewership (e.g., of the content creator's content on a content sharing platform). The prompt may be provided as input to a generative machine learning model (e.g., content item representation generator 140 of FIG. 1) that returns one or more suggestions for additional content items. In some embodiments, metrics related to content items of the content creator may be provided to the content item representation generator in addition to the prompt. The output of the content item representation generator may be displayed to the content creator within second portion 320 of the UI. The output may include one or more representations of content items. Each representation may include attributes of the content item, such as a title, a description, a length of the content item, etc. The representation may be a natural language explanation of the additional content item.

FIG. 3B depicts an example user interface for displaying graphical representations of content items to a content creator. For example, client device 330 may be a device of a content creator and may display a UI including a first portion 340 and a second portion 350. The UI may be provided by a server of a content platform (e.g., platform server 110 of FIG. 1). Client device 330 may be a mobile device, a laptop, a desktop, a tablet, or any other suitable device for interacting with the server of the content platform. First portion 340 may include text information to be displayed to a content creator. In some embodiments, the information may be a description of the additional content items that are displayed in second portion 350. Second portion 350 may include one or more graphical representations of additional content items generated by the generative machine learning model. In some embodiments, the graphical representation includes a title of the additional content item and an image (e.g., a thumbnail) representative of the additional content item. In some embodiments, the graphical representation may only include an image representative of the additional content item.

FIG. 3C depicts an example user interface for displaying video clip representations of content items to a content creator. For example, client device 360 may be a device of a content creator and may display a UI including a first portion 370 and a second portion 380. First portion 370 may include text information to be displayed to the content creator and may include a description of the additional content items that are displayed in second portion 380. Second portion 380 may include media player 390 and one or more graphical representations of additional content items generated by the generative machine learning model. Media player 390 may display a video clip associated with an additional content item after the content creator interacts with (e.g., clicks on, selects, etc.) one of the graphical representations.

In some embodiments, the UI displayed to a content creator may include a combination of textual, graphical, and/or video clip representations of additional content items. In some embodiments, a disclaimer may be included in the UI.

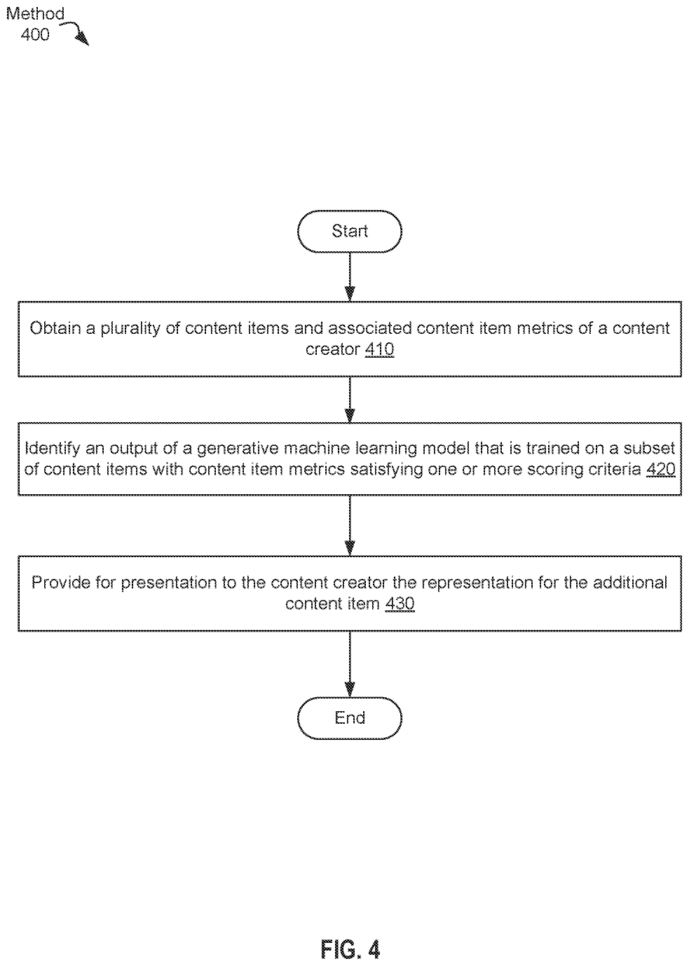

FIG. 4 is a flow diagram of a method 400 for generating representations of content items, according to some embodiments. Method 400 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, method 400 may be performed, in part, by platform server 110, user device 160, and/or content creator device 170 of FIG. 1. In some embodiments, a non-transitory machine-readable storage medium stores instructions that when executed by a processing device (e.g., of platform server 110) cause the processing device to perform method 400.

For simplicity of explanation, method 400 is depicted and described as a series of operations. However, operations in accordance with this disclosure can occur in various orders and/or concurrently and with other operations not presented and described herein. Furthermore, not all illustrated operations may be performed to implement method 400 in accordance with the disclosed subject matter. In addition, those skilled in the art will understand and appreciate that method 400 could alternatively be represented as a series of interrelated states via a state diagram or events.

Referring to FIG. 4, at block 410, the processing logic implementing method 400 may obtain a plurality of content items of a content creator and associated content item metrics. The plurality of content items may include content items of a first modality (e.g., audio, video, image, text, etc.).

At block 420, the processing logic may identify an output of a generative machine learning model that is trained on a subset of content items (e.g., of platform server 110) with content item metrics satisfying one or more scoring criteria. The generative machine learning model may include a generative adversarial network having a generator trained to generate representations for additional content items similar to the subset of content items, and a discriminator trained to reject generated representations for additional content items that are dissimilar to the plurality of content items. The generative machine learning model may be trained by obtaining a plurality of content items of a content item platform, obtaining a plurality of content item metrics associated with each content item of the plurality of content items of the content item platform, selecting, from the plurality of content items, the subset of content items each having content item metrics that satisfy the one or more scoring criteria, selecting a prompt template of a plurality of prompt templates to present information pertaining to the subset of content items (e.g., metadata characteristics of the subset of content items), modifying the prompt template based on the content item metrics of the subset of content items, and providing the modified prompt template as training input to the generative machine learning model. A content item metric may include a number of times users watched the content item, a duration of time users watch the content item, a number of “likes” given to the content item, and/or an amount of revenue generated by the content item. The output of the generative machine learning model may provide a representation for an additional content item, which when created based on the representation, is predicted to have one or more content item metrics that satisfy the one or more scoring criteria. The representation for the additional content item may include a title for the additional content item, a description for the additional content item, an image to graphically represent the additional content item, and/or a video clip to graphically represent the additional content item. The scoring criteria may include one or more thresholds that each can be used to compare with a respective score determined for the content item for one or more of the content item metrics. For example, multiple scores can be determined for the content item based on different content item metrics, and then compared against corresponding thresholds of the scoring criteria. In another example, a single score can be determined for the content item by combining scores corresponding to different content item metrics, and the single score can be compared against a threshold of the scoring criterion. Different weights can be used for different content item metrics when determining the single score of the content item (e.g., weights can vary based on importance of/interest in a specific content item metric for a content creator.)

At block 430, the processing logic may provide for presentation to the content creator the representation for the additional content item. In some embodiments, the output of the generative machine learning model may provide representations for multiple additional content items, which can be presented to the content creator in a UI (e.g., and sorted based on their predicted content item metrics and/or scores).

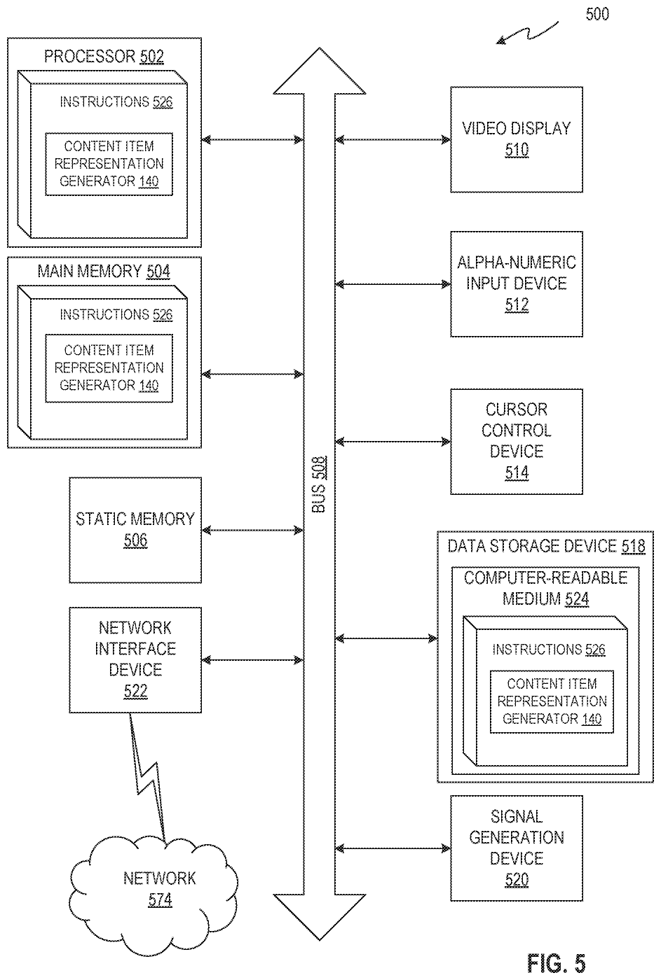

FIG. 5 is a block diagram illustrating a computer system 500, according to some embodiments. In some embodiments, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processing device 502, a volatile memory 504 (e.g., Random Access Memory (RAM)), a non-volatile memory 506 (e.g., Read-Only Memory (ROM) or Electrically-Erasable Programmable ROM (EEPROM)), and a data storage device 518, which may communicate with each other via a bus 508.

Processing device 502 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 500 may further include a network interface device 522 (e.g., coupled to network 574). Computer system 500 also may include a video display unit 510 (e.g., an LCD), an alphanumeric input device 512 (e.g., a keyboard), a cursor control device 514 (e.g., a mouse), and a signal generation device 520.

In some embodiments, data storage device 518 may include a non-transitory computer-readable storage medium 524 (e.g., non-transitory machine-readable medium) on which may store instructions 526 encoding any one or more of the methods or functions described herein, including instructions encoding components of FIG. 1 (e.g., platform server 110 and/or content item representation generator 140) and for implementing methods described herein.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A method comprising:
obtaining a plurality of content items of a content creator and associated content item metrics;
identifying, based on the plurality of content items and associated content item metrics, an output of a generative machine learning model that is trained on a subset of content items with content item metrics satisfying one or more scoring criteria, wherein the output of the generative machine learning model provides a representation for an additional content item, wherein the additional content item, when created based on the representation, is predicted to have one or more content item metrics that satisfy the one or more scoring criteria; and
providing for presentation to the content creator the representation for the additional content item.

2. The method of claim 1, wherein a content item metric of the associated content item metrics comprises at least one of:
a number of times users watched the content item,
a duration of time users watched the content item,
a number of “likes” given to the content item, or
an amount of revenue generated by the content item.

3. The method of claim 1, wherein the representation for the additional content item comprises at least one of:
a title for the additional content item,
a description for the additional content item,
an image to graphically represent the additional content item, or
a video clip to graphically represent the additional content item.

4. The method of claim 1, wherein the generative machine learning model is trained by:
obtaining a plurality of content items of a content item platform;
obtaining a plurality of content item metrics associated with each content item of the plurality of content items of the content item platform;
selecting, from the plurality of content items, the subset of content items each having content item metrics that satisfy the one or more scoring criteria; and
providing the subset of content items as training input to the generative machine learning model.

5. The method of claim 4, wherein the generative machine learning model comprises a generative adversarial network having:
a generator trained to generate representations for additional content items similar to the plurality of content items; and
a discriminator trained to reject generated representations for additional content items that are dissimilar to the plurality of content items.

6. The method of claim 1, wherein the generative machine learning model is trained by:
obtaining a plurality of content items of a content item platform;
obtaining a plurality of content item metrics associated with each content item of the plurality of content items of the content item platform;
selecting, from the plurality of content items, the subset of content items each having content item metrics that satisfy the one or more scoring criteria;
selecting a prompt template of a plurality of prompt templates to present information pertaining to the subset of content items;
modifying the prompt template based on the content item metrics of the subset of content items; and
providing the modified prompt template as training input to the generative machine learning model.

7. The method of claim 6, wherein the information pertaining to the subset of content items comprises one or more metadata characteristics of the subset of content items.

8. A computing system, comprising:
a memory; and
one or more processors, coupled to the memory, to:
obtain a plurality of content items of a content creator and associated content item metrics;
identify, based on the plurality of content items and associated content item metrics, an output of a generative machine learning model that is trained on a subset of content items with content item metrics satisfying one or more scoring criteria, wherein the output of the generative machine learning model provides a representation for an additional content item, wherein the additional content item, when created based on the representation, is predicted to have one or more content item metrics that satisfy the one or more scoring criteria; and
provide for presentation to the content creator the representation for the additional content item.

9. The system of claim 8, wherein a content item metric of the associated content item metrics comprises at least one of:
a number of times users watched the content item,
a duration of time users watched the content item,
a number of “likes” given to the content item, or
an amount of revenue generated by the content item.

10. The system of claim 8, wherein the representation for the additional content item comprises at least one of:
a title for the additional content item,
a description for the additional content item,
an image to graphically represent the additional content item, or
a video clip to graphically represent the additional content item.

11. The system of claim 8, wherein the generative machine learning model is trained by:
obtaining a plurality of content items of a content item platform;
obtaining a plurality of content item metrics associated with each content item of the plurality of content items of the content item platform;
selecting, from the plurality of content items, the subset of content items each having content item metrics that satisfy the one or more scoring criteria; and
providing the subset of content items as training input to the generative machine learning model.

12. The system of claim 11, wherein the generative machine learning model comprises a generative adversarial network having:
a generator trained to generate representations for additional content items similar to the plurality of content items; and
a discriminator trained to reject generated representations for additional content items that are dissimilar to the plurality of content items.

13. The system of claim 8, wherein the generative machine learning model is trained by:
obtaining a plurality of content items of a content item platform;
obtaining a plurality of content item metrics associated with each content item of the plurality of content items of the content item platform;
selecting, from the plurality of content items, the subset of content items each having content item metrics that satisfy the one or more scoring criteria;
selecting a prompt template of a plurality of prompt templates to present information pertaining to the subset of content items;
modifying the prompt template based on the content item metrics of the subset of content items; and
providing the modified prompt template as training input to the generative machine learning model.

14. The system of claim 13, wherein the information pertaining to the subset of content items comprises one or more metadata characteristics of the subset of content items.

15. A non-transitory computer-readable storage medium comprising instructions that, when executed by one or more processors, cause the one or more processors to perform operations comprising:
obtaining a plurality of content items of a content creator and associated content item metrics;
identifying, based on the plurality of content items and associated content item metrics, an output of a generative machine learning model that is trained on a subset of content items with content item metrics satisfying one or more scoring criteria, wherein the output of the generative machine learning model provides a representation for an additional content item, wherein the additional content item, when created based on the representation, is predicted to have one or more content item metrics that satisfy the one or more scoring criteria; and
providing for presentation to the content creator the representation for the additional content item.

16. The non-transitory computer-readable storage medium of claim 15, wherein a content item metric of the associated content item metrics comprises at least one of:
a number of times users watched the content item,
a duration of time users watched the content item,
a number of “likes” given to the content item, or
an amount of revenue generated by the content item.

17. The non-transitory computer-readable storage medium of claim 15, wherein the representation for the additional content item comprises at least one of:
a title for the additional content item,
a description for the additional content item,
an image to graphically represent the additional content item, or
a video clip to graphically represent the additional content item.

18. The non-transitory computer-readable storage medium of claim 15, wherein the generative machine learning model is trained by:
obtaining a plurality of content items of a content item platform;
obtaining a plurality of content item metrics associated with each content item of the plurality of content items of the content item platform;
selecting, from the plurality of content items, the subset of content items each having content item metrics that satisfy the one or more scoring criteria; and
providing the subset of content items as training input to the generative machine learning model.

19. The non-transitory computer-readable storage medium of claim 18, wherein the generative machine learning model comprises a generative adversarial network having:
a generator trained to generate representations for additional content items similar to the plurality of content items; and
a discriminator trained to reject generated representations for additional content items that are dissimilar to the plurality of content items.

20. The non-transitory computer-readable storage medium of claim 15, wherein the generative machine learning model is trained by:
obtaining a plurality of content items of a content item platform;
obtaining a plurality of content item metrics associated with each content item of the plurality of content items of the content item platform;
selecting, from the plurality of content items, the subset of content items each having content item metrics that satisfy the one or more scoring criteria;
selecting a prompt template of a plurality of prompt templates to present information pertaining to the subset of content items;
modifying the prompt template based on the content item metrics of the subset of content items; and
providing the modified prompt template as training input to the generative machine learning model.
